(19) United States
(12) Patent Application Publication
(10) Pub. No.: US 2018/0123759 A1
(43) Pub. Date: May 3, 2018

(54) METHOD FOR INDICATING RESOURCE OF MULTI-USER SUPERPOSITION TRANSMISSION, BASE STATION AND USER EQUIPMENT

(71) Applicant: SHARP KABUSHIKI KAISHA, Sakai City, Osaka (JP)

(72) Inventors: MENG ZHANG, Shanghai (CN); QI JIANG, Shanghai (CN); RENMAO LIU, Shanghai (CN)

(21) Appl. No.: 15/573,637

(22) PCT Filed: May 12, 2016
(86) PCT No.: PCT/CN2016/081847

§ 371 Date: Nov. 13, 2017

(30) Foreign Application Priority Data
May 14, 2015 (CN) 201510246526.2

(51) Int. Cl. H04L 5/00; H04W 72/04

(52) U.S. Cl. CPC H04L 5/0051; H04J 11/00; H04W 72/042

(57) ABSTRACT

Provided in the present invention are a method for indicating resources applicable to a user equipment (UE) in an MUST mode, a corresponding base station and a UE. The method performed in a base station according to an embodiment of the present invention includes: generating a DCI message for a first UE in the MUST mode, the DCI message including information indicating a resource overlapping region of the first UE and a UE paired therewith; and transmitting the DCI message to the first UE.

### TECHNICAL FIELD

The present invention relates to the technical field of wireless communications. More specifically, the present invention relates to a method for indicating inter-equipment communication resources, a corresponding base station, and a user equipment.

### BACKGROUND

Modern wireless mobile communication systems present two significant characteristics: high-speed broadband (for example, the bandwidth of the Fourth Generation wireless mobile communication system can reach 100 MHz and the downlink speed is up to 1 Gbps); and mobile interconnection, which promotes emerging services such as mobile internet access, mobile phone video-on-demand, online navigation and the like. These two characteristics propose relatively high requirements for the wireless mobile communication technology. Such requirements mainly include: ultrahigh-speed wireless transmission, inter-region interference suppression, mobile reliable signal transmission, distributed/centralized signal processing and the like. To satisfy the development requirements above, in a future, more enhanced Fourth Generation (4G) or Fifth Generation (5G) wireless mobile communication system, various corresponding key technologies will begin to be proposed and demonstrated, arousing the attention of researchers in the field.

In October 2007, the International Telecommunication Union (ITU) approved the Worldwide Interoperability for Microwave Access (WiMax) system to become the fourth 3G system standard. This event occurring at the end of 3G age is actually the rehearsing of the 4G standard competition. In fact, in order to respond to the challenge of wireless IP technical flow represented by a wireless local area network and WiMax, since 2005, the Third Generation Partnership Project (3GPP) organization has started to carry out brand-new system upgrade, i.e., standardization of a Long Term Evolution (LTE) system. It is a quasi fourth generation system based on an Orthogonal Frequency Division Multiplexing (OFDM) technology, the first edition of the quasi fourth generation system was released early in 2009, and the quasi 4G system began to be commercially available in succession all over the world in 2010. Meanwhile, the 3GPP organization started standardization customization of the Fourth Generation (4G) wireless mobile communication system the first half of 2008. This system is called a Long Term Evolution Advanced (LTE-A) system. The key standardization document of the physical layer process of the system was completed early in 2011. In November 2011, the ITU organization officially announced, in Chongqing China, that the LTE-A system and the WiMax system were two official standards of the 4G system. At present, the commercial process of the LTE-A system is being developed gradually worldwide.

According to the challenges in the next 10 years, the following development requirements are substantially provided for an enhanced 4G wireless mobile communication system:

a higher wireless broadband rate, with a focus on optimizing a local cell hotspot area;

further enhancement of user experience, with a particular need to optimize communication services of cell boundary regions;

a need to continue studying new technology capable of improving the utilization efficiency of a spectrum, considering that an available spectrum cannot be expanded 1000 times;

a high-band spectrum (5GHz or even higher) certainly being put into use to obtain a larger communication bandwidth;

collaborative work of existing networks (2G/3G/4G, WLAN, WiMax, etc.) to share data traffic;

specific optimization for different businesses, applications and services;

strengthening of the system's ability to support large-scale machine communications;

flexible, intelligent and inexpensive network planning and network deployment;

designing of a solution to save power consumption of networks and battery consumption of user equipment.

In a 3GPP LTE system in the related art, multiple sets of data can be transmitted on a single data stream, it is also known as the multi-user (simply referred to as MU) transmission technology. However, the traditional MU technology can obtain better performance only when channels of users are orthogonal as much as possible, which restricts the flexibility of user scheduling to some extent. Therefore, a new research project, i.e., a research on multi-user superposition transmission (simply referred to as MUST) was discussed in the 3GPP RAN#67 Plenary Session. The main purpose of the research is to realize a function of transmitting multiple pieces of user information through single-stream data in a mutual superposition manner by adjusting the power of multiple user modulation signals. Compared with the traditional MU technology, the multi-user superposition transmission technology does not require orthogonality between channels of a user to a base station. Thus, by adopting the MUST technology, the base station can schedule the user more flexibly. Currently, Release 13 specifies the MUST technology in which each data stream can only support two users at most.

However, the following several problems may be encountered when the MUST technology is adopted in the traditional LTE system:

When the MUST technology is adopted, a UE requiring interference cancellation needs to know a resource allocation type of a UE paired therewith. In the current downlink control indicator (simply referred to as DCI) of the LTE, there is no indication information capable of indicating the resource allocation type of the paired UE.

When the MUST technology is adopted, in a case where only a part of frequency domain resources of the UE requiring interference cancellation overlaps with the UE paired therewith, the UE requiring interference cancellation needs to specifically know which resources overlap with the paired UE and which resources are unique to the UE itself. This is because methods for the UE to process (especially interference cancellation) overlapping resources and unique resources are different. In the current downlink control indicator of the LTE, there is no indication information for realizing the above function.

Thus, the resource indication method for the user equipment in an MUST mode needs to be redesigned.

### SUMMARY

In order to solve at least some of the above-mentioned problems, the present invention provides a resource indicating mechanism applicable to a user equipment (UE) in an MUST mode, a corresponding base station and a user equipment.

According to a first aspect of the present invention, there is provided a method performed in a base station, including: generating a DCI message for a first UE in the MUST mode, the DCI message including information indicating a resource overlapping region of the first UE and a UE paired therewith; and transmitting the DCI message to the first UE.

In some embodiments of the present invention, the DCI message further includes information indicating resource allocation types of the first UE and the UE paired therewith. The resource allocation types include a resource allocation type 0, a resource allocation type 1, and a resource allocation type 2. The information indicating the resource allocation types of the first UE and the UE paired therewith may occupy 3 or 4 bits.

In some embodiments of the present invention, the information indicating the resource overlapping region of the first UE and the UE paired therewith includes a bitmap having a length of N, wherein N is the total number of available resource positions in a system; and each bit in the bitmap corresponds to one resource position. The resource position may be described with regard to a resource block (RB) or with regard to a resource block group (RBG).

In some embodiments of the present invention, the information indicating the resource overlapping region of the first UE and the UE paired therewith includes a bitmap having a length of N, wherein N is the number of resource positions allocated to the first UE; and each bit in the bitmap corresponds to one resource position.

In some embodiments of the present invention, the resource allocation types of the first UE and the UE paired therewith are the same; and the resource overlapping region is continuous; wherein the information indicating the resource overlapping region of the first UE and the UE paired therewith may be any one of the following: including information indicating a start position of the resource overlapping region and information indicating an end position of the resource overlapping region; including the information indicating the start position of the resource overlapping region and information indicating the length of the resource overlapping region; or, including the information indicating the end position of the resource overlapping region and the information indicating the length of the resource overlapping region.

In some embodiments of the present invention, the resource allocation types of the first UE and the UE paired therewith are both a resource allocation type 2; and the resource overlapping region is continuous; wherein the information indicating the resource overlapping region of the UE and the UE paired therewith represents information of the resource overlapping region in the following way:

Floor(RIV_overlap/N)+1 represents a frequency domain span of the resource overlapping region, RIV_overlap mod N represents the start position of the resource overlapping region,

wherein RIV overlap is a value of the information indicating the resource overlapping region of the UE and the UE paired therewith, and N is a pre-configured parameter.

In some embodiments of the present invention, the method further includes a pre-configuration step: sending an RRC configuration message to configure the first UE in the MUST mode.

According to a second aspect of the present invention, there is provided a method performed in a user equipment (UE), including: receiving, from a base station, a downlink control indicator (DCI) message for the UE that satisfies a multi-user superposition transmission (MUST) mode, the DCI message including information indicating a resource overlapping region of the UE and a UE paired therewith; and determining the resource overlapping region of the UE and the UE paired therewith according to the DCI message.

According to a third aspect of the present invention, there is provided a base station, including: a. generation module, configured to generate a downlink control indicator (DCI) message for a first user equipment (UE) in a multi-user superposition transmission (MUST) mode, the DCI message including information indicating a resource overlapping region of the first UE and a UE paired therewith; and a sending module, configured to transmit the DCI message to the first UE.

According to a fourth aspect of the present invention, there is provided a user equipment (UE), including: a reception module, configured to receive, from a base station, a downlink control indicator (DCI) message for the UE that satisfies a multi-user superposition transmission (MUST) mode, the DCI message including information indicating a resource overlapping region of the UE and a UE paired therewith; and a processing unit, configured to determine the resource overlapping region of the UE and the UE paired therewith according to the DCI message.

### DESCRIPTION OF THE DRAWINGS

The above and other features of the present invention will become more apparent from the following detailed description taken in conjunction with the accompanying drawings, wherein:

FIG. 1 illustrates a flow diagram of a method for indicating resources applicable to a user equipment (UE) in an MUST mode according to an embodiment of the present invention;

FIG. 2 illustrates a flow diagram of a method for indicating resources applicable to a user equipment (UE) in an MUST mode according to another embodiment of the present invention;

FIG. 3 illustrates a schematic view of an example of indicating resource overlapping of an interference cancellation UE and a UE paired therewith according to an embodiment of the present invention;

FIG. 4 illustrates a structural schematic view of a base station according to an embodiment of the present invention; and

FIG. 5 illustrates a structural schematic view of a user equipment according to an embodiment of the present invention.

In the accompanying drawings, identical or similar structures are all marked with identical or similar drawing references.

### DESCRIPTION OF THE EMBODIMENTS

Hereinbelow, a mechanism for indicating resources of applicable to a user equipment (UE) in a MUST mode, a corresponding base station and a user equipment provided in the present invention will be described in detail in conjunction with the drawings and specific embodiments.

Note that the present invention shall not be limited to the embodiments described below. In addition, for simplicity, a detailed description of the known art not directly related to the present invention is omitted to prevent confusion with the understanding of the present invention.

In the following description, an LTE mobile communication system and its subsequent evolved releases are used as exemplary application environments to set forth a pluralities of embodiments of the present invention in detail. Note, however, that the present invention is not limited to the following embodiments, and may be applicable to more other wireless communication systems, such as a 5G cellular communication system in the future.

As described above, currently, Release 13 specifies the MUST technology in which each data stream can only support two users at most. An application scenario of the MUST technology in which each data stream supports two users is mainly taken into consideration hereinafter. Two UEs supported in one data stream are paired with each other. When the MUST technology is adopted, the UE which requires interference cancellation will perform different interference cancellation processing on resources overlapped with the UE paired therewith and unique resources. Therefore, the UE which requires interference cancellation needs to know not only its own resource allocation, but also the resource overlapping situation of the UE and the resources paired therewith. Hereinafter, for ease of description, the UE which requires interference cancellation is referred to as an interference cancellation UE (sometimes also referred to as a first UE), while the other UE is referred to as a paired UE.

According to the regulations of 3GPP TS 36.213, each UE may configure the following three resource allocation types: a Resource Allocation Type 0, a Resource Allocation Type 1, and a Resource Allocation Type 2. The resource allocation type configured by each UE is indicated by a “Resource Allocation Header” field in the DCI, wherein in a case where the field does not exist, it indicates that the UE has configured the Resource Allocation Type 2; in a case where the value of this field is “0”, it indicates that the UE has configured the Resource Allocation Type 0; and in a case where the value of this field is “1”, it indicates that the UE has configured the Resource Allocation Type 1.

For the Resource Allocation Type 0 and the Resource Allocation Type 1, a “resource block assignment” field in the DCI is used to indicate the specific resource allocation for the UE. For the Resource Allocation Type 2, a “resource indication value” field in the DCI is used to indicate the specific resource allocation for the UE. Details are described as follows:

The Resource Allocation Type 0: first, all available resource blocks (RBs) in a system are divided into several resource block groups (RBGs); and then a bitmap is used in the “Resource block assignment” field in the DCI to indicate which RBGs are allocated to the UE.

The Resource Allocation Type 1: first, all available RBs in the system are divided into several RB subsets; a “Subset” field in the DCI is used to indicate which RB subset is allocated to the UE; and a bitmap is used in the “Resource block assignment” field in the DCI to indicate which RBs of the RB subset are allocated to the UE.

The Resource Allocation Type 2: a resource indication value (simply referred to as RIV) is used to indicate a starting RB allocated to the UE and a frequency domain span of resources allocated to the UE in the following way:

Floor(RIV/N)+1 represents the number of continuous RBs that are occupied by the resources allocated to the UE; and RIV mod N represents a position of the starting RB of the resources allocated to the UE; wherein Floor(X) represents the rounding down of X, mod represents a modulo operation, N may be the total number of available RBs (or RBGs) of the system or may be a parameter configured by RRC, and N is generally a positive integer.

It can be seen that, according to the related art, the UE may know its own resource allocation through the DCI, but it cannot know the resource allocation of the UE paired therewith or cannot know the resource overlapping situation of the UE and the UE paired therewith. Therefore, an embodiment of the present invention proposes that indication information indicating the resource overlapping of the discussed UE and the UE paired therewith is added to an existing DCI, so as to generate a DCI applicable to the MUST mode.

Preferably, an embodiment of the present invention further proposes that the existing DCI may be extended to include indication information indicating the resource allocation types of the discussed UE (i.e., the UE at which the DCI is aimed) and the UE paired therewith. This may be realized by extending the existing “Resource Allocation Header” field in the DCI, so as to not only indicate the resource allocation type of the discussed UE (i.e., the UE at which the DCI is aimed), but also indicate the resource allocation type of its paired UE; alternatively, this may also be realized by adding a new field to the DCI to indicate the resource allocation type of the paired UE. It should be understood that, the DCI that satisfies the MUST mode does not necessarily include the indication information indicating the resource allocation type of the paired UE. In some instances, for example, it is specified that in a case where a pair of paired UEs that adopt the MUST have to use the same resource allocation type, the DCI does not need to include the indication information indicating the resource allocation type of the paired UE.

The embodiments of the present invention are described in detail with reference to the drawings below.

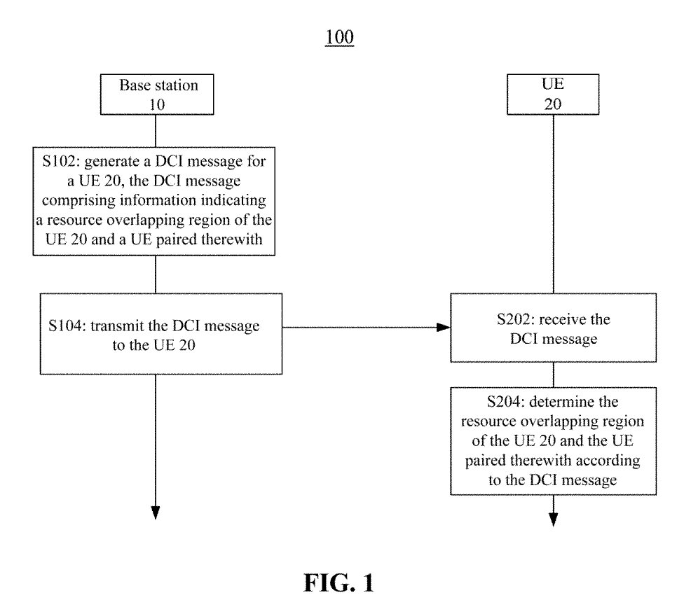

FIG. 1 illustrates a flow diagram of a method 100 for indicating resources applicable to a user equipment (UE) in an MUST mode in a communication system that supports MUST according to an embodiment of the present invention. The communication system may include one or more base stations supporting MUST transmission and one or more user equipment (UEs) supporting MUST. Although FIG. 1 only illustrates one base station 10 and one UE 20, the communication system may include a plurality of base stations and UEs. The present invention is not limited in this regard. Interference cancellation needs to be performed on the UE 20 in the figure; and for ease of illustration, the UE 20 is also referred to as an interference cancellation UE.

In step S102, the base station 10 generates a downlink control indicator (DCI) message for the interference cancellation UE 20 (sometimes also referred to as a first UE) in the MUST mode, the DCI message including information indicating a resource overlapping region of the interference cancellation UE 20 and a UE paired therewith. The base station 10 knows the resource allocation of all UEs that it serves; therefore, the base station 10 may configure the information indicating the resource overlapping region of the interference cancellation UE 20 and the UE paired therewith in the DCI according to the resource overlapping region of the interference cancellation UE 20 and the UE paired therewith. It should be understood that the information (for example, the existing “resource block assignment” and/or “resource indication value”) indicating the resource allocation for the UE 20 is further included in the DCI message. In regard to the existing fields of the DCI already specified in the existing specifications (such as 3GPP TS 36.213), repeated descriptions thereof will be omitted in the present invention.

Hereinafter, an implementation of the information indicating the resource overlapping region of the interference cancellation UE 20 and the UE paired therewith is described in detail by several examples.

As a first example, the base station 10 uses a bitmap Y having a length of N to indicate a specific position where resources of the paired UE and the interference cancellation UE are overlapped.

In the first example, N is the total number of resource positions, i.e., resource blocks (simply referred to as RBs) or resource block groups (simply referred to as RBGs), that may be allocated in the system.

Each bit in the bitmap Y corresponds to one resource position (RB or RBG); the value “1” represents that the resource overlapping occurs at this position; and the value “0” represents that the resource overlapping does not occur at this position.

If N=10 and Y=1 0 0 1 0 0 1 0 0 0, it represents that the resources of the paired UE and the interference cancellation UE at a first RB (or RBG), a fourth RB (or RBG), and a seventh RB (or RBG) are overlapped, wherein the total resources that may be allocated in the system are 10 RBs (or RBGs).

As a second example, the base station 10 uses a bitmap Y having a length of N as the information indicating the resource overlapping region of the first UE and the UE paired therewith, so as to indicate the specific position where the resources of the paired UE and the interference cancellation UE are overlapped.

In the second example, N is the number of resource positions (i.e., RBs or RBGs) allocated to the interference cancellation UE.

Each bit in the bitmap Y corresponds to one resource position (RB or RBG); the value “1” represents that the resource overlapping occurs at this position; and the value “0” represents that the resource overlapping does not occur at this position.

If N=10 and Y=1 0 0 1 0 0 1 0 0 0, it represents that the resources of the paired UE and the interference cancellation UE at a first RB (or RBG), a fourth RB (or RBG), and a seventh RB (or RBG) allocated to the interference cancellation UE are overlapped, wherein the resources allocated to the interference cancellation UE are 10 RBs (or RBGs).

As a third example, the resource allocation types of the interference cancellation UE and its paired UE are the same, i.e., both the resource allocation types are a Resource Allocation Type 0, or a Resource Allocation Type 1, or a Resource Allocation Type 2; and the overlapping resources are required to be continuous in a frequency domain.

The base station adds indication information of a start position and an end position of the resource overlapping region into the DCI of the interference cancellation UE.

Herein, the start position indicates a position of RB (or RBG) where the resource overlapping of the interference cancellation UE and its paired UE begins.

The end position indicates a position where the resource overlapping of the interference cancellation UE and its paired UE ends.

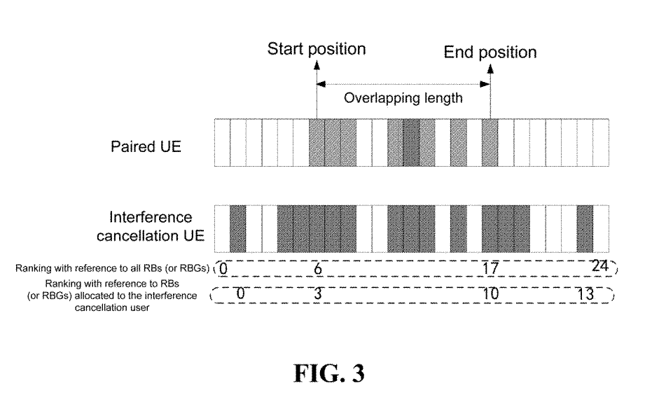

Referring to the situation illustrated in FIG. 3, each block represents one RB (or RBG); a total of 25 RBs (RBGs) may be allocated in the system, and are numbered 0 . . . 24; shaded blocks represent RBs (or RBGs) allocated to a corresponding UE.

In the case of FIG. 3, in a case where ranking is performed with reference to all RBs (or RBGs) that may be allocated in the system, then: a corresponding start position=6, and a binary representation is 00110; a corresponding end position=17, and a binary representation is 10001.

Alternatively, in the case of FIG. 3, in a case where ranking is performed with reference to RBs (or RBGs) allocated to the interference cancellation UE, then: a corresponding start position=3, and a binary representation is 0011; a corresponding end position=10, and a binary representation is 1010.

As a fourth example, the resource allocation types of the interference cancellation UE and its paired UE are the same, i.e., both the resource allocation types are the Resource Allocation Type 0, or the Resource Allocation Type 1, or the Resource Allocation Type 2; and the overlapping resources are specified to be continuous in a frequency domain.

The base station adds indication information of the start position and an overlapping length of the resource overlapping region into the DCI of the interference cancellation UE 20.

Herein, the start position indicates a position of RB (or RBG) where the resource overlapping of the interference cancellation UE and its paired UE begins.

The overlapping length indicates a length of the resource overlapping of the interference cancellation UE and its paired UE.

Referring to the situation illustrated in FIG. 3, in the case where ranking is performed with reference to all RBs (or RBGs) that may be allocated in the system, then: a corresponding start position=6, and a binary representation is 00110; a corresponding overlapping length=11, and a binary representation is 01011.

Alternatively, in the case of FIG. 3, in the case where ranking is performed with reference to RBs (or RBGs) allocated to the interference cancellation UE, then: a corresponding start position=3, and a binary representation is 0011; a corresponding overlapping length is 7, and a binary representation is 0111.

As a fifth example, the resource allocation types of the interference cancellation UE and its paired UE are the same, i.e., both the resource allocation types are the Resource Allocation Type 0, or the Resource Allocation Type 1, or the Resource Allocation Type 2; and the overlapping resources are specified to be continuous in a frequency domain.

The base station adds indication information of the end position and the overlapping length of the resource overlapping region into the DCI of the interference cancellation UE.

Herein, the end position indicates a position where the resource overlapping of the interference cancellation UE and its paired UE ends.

The overlapping length indicates a frequency domain span of the resource overlapping of the interference cancellation UE and its paired UE.

In the case of FIG. 3, in the case where ranking is performed with reference to all RBs (or RBGs) that may be allocated in the system, then: a corresponding end position=17, and a binary representation is 10001; a corresponding overlapping length=11, and a binary representation is 01011.

Alternatively, in the case of FIG. 3, in the case where ranking is performed with reference to RBs (or RBGs) allocated to the interference cancellation UE, then: a corresponding end position=10, and a binary representation is 1010; a corresponding overlapping length=7, and a binary representation is 0111.

As a sixth example, the resource allocation types of the interference cancellation UE and its paired UE are both the Resource Allocation Type 2; and the overlapping resources are required to be continuous in a frequency domain.

The base station adds a resource indication value (represented as RIV_overlap) of the resource overlapping region into the DCI of the interference cancellation; the specific position where the resources of the interference cancellation UE and the paired UE are overlapped is indicated in the following way:
Floor(RIV_overlap/N)+1 represents the frequency domain span of the resource overlapping region;
RIV_overlap mod N represents the start position of the resource overlapping region.

Herein, Floor(X) represents the rounding down of X; mod represents a modulo operation; N may be the total number of available RBs (or RBGs), or may be a parameter configured by RRC; and N is generally a positive integer.

Then, in step S104, the DCI message generated in step S102 is transmitted to the UE 20.

In step S202, the UE 20 receives the DCI message transmitted by the base station.

In step S204, the UE 20 determines the resource overlapping region of the UE 20 and its paired UE according to the DCI message (for example, the information in the DCI message that indicates the resource overlapping region of the interference cancellation UE and its paired UE). The UE 20, after knowing the resource overlapping region of the UE 20 and its paired UE, may perform different interference cancellation processing on a PDSCH received subsequently for the overlapping region and the region unique to the UE 20 itself.

In some embodiments, the method 100 further includes a pre-configuration step prior to step S102: the base station 10 transmits to the UE 20 an RRC configuration message for configuring the UE 20 in the MUST mode. Then, after receiving the RRC configuration message, the UE 20 configures itself in the MUST mode.

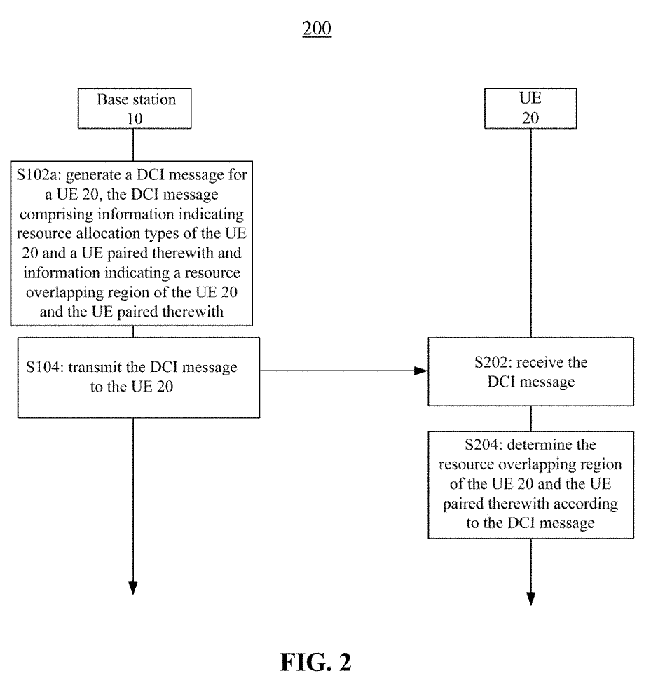

FIG. 2 illustrates a flow diagram of a method 200 for indicating resources applicable to a user equipment (UE) in an MUST mode in a communication system that supports MUST according to another embodiment of the present invention.

The embodiment of FIG. 2 differs from the embodiment of FIG. 1 in that, the DCI for the interference cancellation UE 20 that satisfies MUST includes not only the information indicating the resource overlapping region of the interference cancellation UE and its paired UE, but also the information indicating the resource allocation types of the interference cancellation UE and its paired UE.

As illustrated in FIG. 2, in step S102a, the base station 10 generates a downlink control indicator (DCI) message for the interference cancellation UE 20 in the MUST mode, the DCI message including the information indicating the resource allocation types of the interference cancellation UE 20 and its paired UE and the information indicating the resource overlapping region of the interference cancellation UE 20 and its paired UE.

Detailed descriptions are already provided for the information indicating the resource overlapping region of the interference cancellation UE 20 and its paired UE in the embodiment provided with reference to FIG. 1; repeated descriptions thereof are omitted herein.

Hereinafter, an implementation of the information indicating the resource allocation types of the interference cancellation UE 20 and its paired UE is described in detail by several examples.

As a first embodiment, the resource allocation header field in the DCI is extended to 3 bits, so as to indicate the resource allocation types of the interference cancellation UE 20 and its paired UE (this length may be configured by RRC or predefined in the system). As an example, the extended resource allocation header field may have the following meanings:

X=000 represents that the interference cancellation UE adopts the Resource Allocation Type 0 and the paired UE adopts the Resource Allocation Type 0.

X=001 represents that the interference cancellation UE adopts the Resource Allocation Type 0 and the paired UE adopts the Resource Allocation Type 1.

X=010 represents that the interference cancellation UE adopts the Resource Allocation Type 0 and the paired UE adopts the Resource Allocation Type 2.

X=011 represents that the interference cancellation UE adopts the Resource Allocation Type 1 and the paired UE adopts the Resource Allocation Type 0.

X=100 represents that the interference cancellation UE adopts the Resource Allocation Type 1 and the paired UE adopts the Resource Allocation Type 1.

X=101 represents that the interference cancellation UE adopts the Resource Allocation Type 1 and the paired UE adopts the Resource Allocation Type 2.

X=110 represents that the interference cancellation UE adopts the Resource Allocation Type 2 and the paired UE adopts the Resource Allocation Type 0.

X=111 represents that the interference cancellation UE adopts the Resource Allocation Type 2 and the paired UE adopts the Resource Allocation Type 1.

In a case where the Resource Allocation Header Field does not exist, it represents that the interference cancellation UE adopts the Resource Allocation Type 2 and the paired UE adopts the Resource Allocation Type 2.

As a second example, the resource allocation header field in the DCI is extended to 4 bits, so as to indicate the resource allocation types of the interference cancellation UE 20 and its paired UE (this length may be configured by RRC or predefined in the system). As an example, the extended resource allocation header field may have the following meanings:

X=0000 represents that the interference cancellation UE adopts the Resource Allocation Type 0 and the paired UE adopts the Resource Allocation Type 0.

X=0001 represents that the interference cancellation UE adopts the Resource Allocation Type 0 and the paired UE adopts the Resource Allocation Type 1.

X=0010 represents that the interference cancellation UE adopts the Resource Allocation Type 0 and the paired UE adopts the Resource Allocation Type 2.

X=0011 represents that the interference cancellation UE adopts the Resource Allocation Type 1 and the paired UE adopts the Resource Allocation Type 0.

X=0100 represents that the interference cancellation UE adopts the Resource Allocation Type 1 and the paired UE adopts the Resource Allocation Type 1.

X=0101 represents that the interference cancellation UE adopts the Resource Allocation Type 1 and the paired UE adopts the Resource Allocation Type 2.

X=0110 represents that the interference cancellation UE adopts the Resource Allocation Type 2 and the paired UE adopts the Resource Allocation Type 0.

X=0111 represents that the interference cancellation UE adopts the Resource Allocation Type 2 and the paired UE adopts the Resource Allocation Type 1.

X=1000 represents that the interference cancellation UE adopts the Resource Allocation Type 2 and the paired UE adopts the Resource Allocation Type 2.

X=1001, 1010, 1011, 1100, 1101, 1110, and 1111 are not used.

As a third example, it is specified through RRC configuration or system predefinition that a pair of UEs using the MUST technology has to use the same Resource Allocation Type. In the third example, the existing resource allocation header field of 1 bit in the DCI is used to indicate the resource allocation types of the interference cancellation UE 20 and its paired UE (the length of 1 bit may be configured by RRC or predefined by the system). As an example, the resource allocation header filed of 1 bit may have the following meanings:

X=0 represents that the interference cancellation UE adopts the Resource Allocation Type 0 and the paired UE also adopts the Resource Allocation Type 0.

X=1 represents that the interference cancellation UE adopts the Resource Allocation Type 1 and the paired UE also adopts the Resource Allocation Type 1.

In a case there the Resource Allocation Header Field does not exist, it represents that the interference cancellation UE adopts the Resource Allocation Type 2 and the paired UE also adopts the Resource Allocation Type 2.

Other steps in FIG. 2 are the same as corresponding steps in FIG. 1, and are not repeatedly described herein.

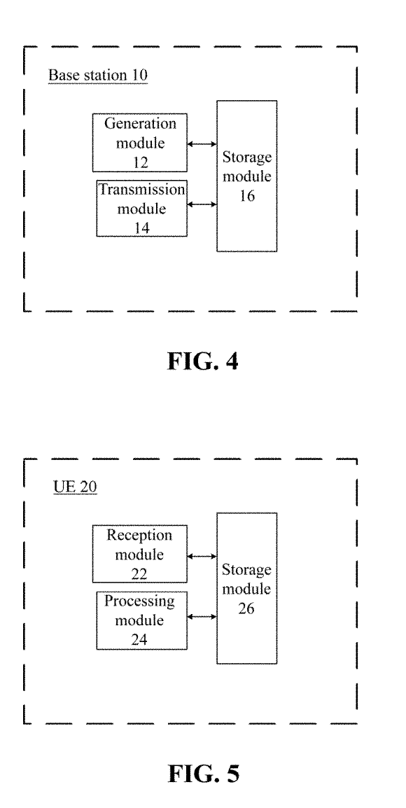

FIG. 4 illustrates a structural schematic view of the base station 10 according to the embodiment of the present invention.

As illustrated in FIG. 4, the base station 10 may include a generation module 12 and a transmission module 14.

The generation module 12 may be configured to generate the DCI message for the UE 20 in the MUST mode, the DCI message including the information indicating the resource overlapping region of the UE 20 and its paired UE. In some embodiments, the DCI message further includes the information indicating the resource allocation types of the UE 20 and its paired UE.

The transmission module 14 may be configured to transmit the DCI message to the UE 20.

In some embodiments, the transmission module 14 is further configured to transmit the RRC configuration message to configure the UE 20 in the MUST module.

In some embodiments of the present invention, the base station 10 further includes a storage module 16 for storing information to be transmitted, for example, information related to resource allocation, the DCI message and the like.

FIG. 5 illustrates a structural schematic view of the user equipment (UE) 20 according to the embodiment of the present invention.

As illustrated in FIG. 5, the UE 20 includes a reception module 22 and a processing module 24.

The reception module 22 may be configured to receive, from the base station, the DCI message that satisfies the MUST mode, the DCI message including the information indicating the resource overlapping region of the UE 20 and its paired UE. In some embodiments, the DCI message further includes the information indicating the resource allocation types of the UE 20 and its paired UE.

The processing unit 24 may be configured to determine the resource overlapping region of the UE 20 and its paired UE according to the DCI message. After knowing the resource overlapping region of the UE 20 and its paired UE, the UE 20 may perform different interference cancellation processing on a PDSCH received subsequently for the overlapping region and the region unique to the UE 20 itself.

In some embodiments, the reception module 22 is further configured to receive the RRC configuration message to configure the UE 20 in the MUST module.

In some embodiments of the present invention, the UE 20 further includes a storage module 26 for storing received information, for example, the received DCI information, the information related to resource allocation, and the like.

The base station 10 and the UE 20 may perform the method for indicating resources applicable to the user equipment in the MUST mode described above with reference to FIG. 1 and FIG. 2; repeated descriptions for functions and operations thereof are omitted herein.

The methods and related equipment of the present invention have been described above in conjunction with preferred embodiments. It should be understood by a person skilled in the art that the methods illustrated above are only exemplary. The methods of the present invention are not limited to the steps or sequences illustrated above. The network nodes and user equipment illustrated above may include more modules, for example, may further include modules that can be developed or developed in the future and are applicable to a base station, an MME or a UE. Various identities illustrated above are only exemplary rather than limiting; and the present invention is not limited to specific information elements serving as examples of these identities. A person skilled in the art could make many alterations and modifications according to the teaching of the illustrated embodiments.

Through the embodiments of the present invention, a user equipment in the MUST mode may be informed of a specific situation of the resource overlapping of the user equipment and a UE paired therewith, such that the user equipment is capable of performing different interference cancellation processing on a received PDSCH for overlapping resources and unique resources, so as to obtain better performance.

It should be understood that the above embodiments of the present invention can be implemented by software, hardware or a combination of software and hardware. For example, various components inside the base station and the user equipment in the embodiments above can be implemented by various devices; and these devices include, but are not limited to: an analog circuit device, a digital circuit device, a digital signal processor (DSP) circuit, a programmable processor, an application specific integrated circuit (ASIC), a field programmable gate array (FPGA), a complex programmable logic device (CPLD) and the like.

In the present application, the term “base station” refers to a mobile communication data and control switching center with a relatively large transmission power and a relatively wide coverage area, and has functions of resource distribution scheduling, data receiving and sending and the like. The term “user equipment” refers to a user mobile terminal, e.g., including a terminal equipment capable of performing wireless communication with a base station or a micro base station, such as a mobile phone, a notebook computer and the like.

Moreover, the embodiments of the present invention disclosed herein can be implemented on a computer program product. More particularly, the computer program product is a product as follows: a product provided with a computer readable medium having computer program logic encoded thereon; when executed on a computing equipment, the computer program logic provides related operations to implement the above technical solutions of the prevent invention. When executed on at least one processor of a computing system, the computer program logic enables the processor to execute the operations (methods) described in the embodiments of the present invention. Such setting of the present invention is typically provided as software, codes and/or other data structures set or encoded on a computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. The software or the firmware or such configuration can be installed on the computing equipment, so that one or more processors in the computing equipment execute the technical solutions described in the embodiments of the present invention.

Although the present invention is already illustrated above in conjunction with the preferred embodiments of the present invention, it will be understood by those skilled in the art that various modifications, replacements and changes can be made to the present invention without departing from the spirit and scope of the present invention. Accordingly, the present invention should not be defined by the above embodiments, but by the appended claims and equivalents thereof.

1. A method performed in a base station, comprising:
generating a downlink control indicator (DCI) message for a first user equipment (UE) in a multi-user superposition transmission (MUST) mode, the DCI message comprising information indicating a resource overlapping region of the first UE and a. UE paired therewith; and
transmitting the DCI message to the first UE.

2. The method according to claim 1, wherein
the DCI message further comprises information indicating resource allocation types of the first UE and the UE paired therewith.

3. The method according to claim 1, wherein
the information indicating the resource overlapping region of the first UE and the UE paired therewith comprises a bitmap having a length of N, where N is the total number of available resource positions in a system or the number of resource positions allocated to the first UE; and
each bit in the bitmap corresponds to one resource position.

4. (canceled)

5. The method according to claim 1, wherein
the resource allocation types of the first UE and the UE paired therewith are the same;
the resource overlapping region is continuous; and
the information indicating the resource overlapping region of the first UE and the UE paired therewith comprises the information indicating the start position of the resource overlapping region and information indicating the length of the resource overlapping region.

6. (canceled)

7. (canceled)

8. (canceled)

9. The method according to claim 2, wherein the resource allocation types comprise a resource allocation type 0, a resource allocation type 1 and the resource allocation type 2; and
the information indicating the resource allocation types of the first UE and the UE paired therewith occupies 3 or 4 bits.

10. A method performed in a user equipment (UE), comprising:
receiving, from a base station, a downlink control indicator (DCI) message for the UE that satisfies a multi-user superposition transmission (MUST) mode, the DCI message comprising information indicating a resource overlapping region of the UE and a UE paired therewith; and
determining the resource overlapping region of the UE and the UE paired therewith according to the DCI message.

11. The method according to claim 10, wherein
the DCI message further comprises information indicating resource allocation types of the UE and the UE paired therewith.

12. The method according to claim 10, wherein
the information indicating the resource overlapping region of the UE and the UE paired therewith comprises a bitmap having a length of N, where N is the total number of available resource positions in a system or the number of resource positions allocated to the UE; and
each bit in the bitmap corresponds to one resource position.

13. (canceled)

14. The method according to claim 10, wherein
the resource allocation types of the UE and the UE paired therewith are the same;
and the resource overlapping region is continuous; and
the information indicating the resource overlapping region of the UE and the UE paired therewith comprises the information indicating the start position of the resource overlapping region and information indicating the length of the resource overlapping region.

15. (canceled)

16. (canceled)

17. (canceled)

18. The method according to claim 11, wherein
the resource allocation types comprise a resource allocation type 0, a resource allocation type 1 and the resource allocation type 2; and
the information indicating the resource allocation types of the UE and the UE paired therewith occupies 3 or 4 bits.

19. A base station, comprising:
a generation module, configured to generate a downlink control indicator (DCI) message for a first user equipment (UE) in a multi-user superposition transmission (MUST) mode, the DCI message comprising information indicating a resource overlapping region of the first UE and a UE paired therewith; and
a transmission module, configured to transmit the DCI message to the first UE.

20. The base station according to claim 19, wherein the DCI message further comprises information indicating resource allocation types of the first UE and the UE paired therewith.

21. The base station according to claim 19, wherein
the information indicating the resource overlapping region of the first UE and the UE paired therewith comprises a bitmap having a length of N, where N is the total number of available resource positions in a system or the number of resource positions allocated to the first UE; and
each hit in the bitmap corresponds to one resource position,

22. (canceled)

23. The base station according to claim 19, wherein the resource allocation types of the first UE and the UE paired therewith are the same;
the resource overlapping region is continuous; and
the information indicating the resource overlapping region of the first UE and the UE paired therewith comprises the information indicating the start position of the resource overlapping region and information indicating the length of the resource overlapping region.

24. (canceled)

25. (canceled)

26. (canceled)

27. The base station according to claim 20, wherein
the resource allocation types comprise a resource allocation type 0, a resource allocation type 1 and the resource allocation type 2; and
the information indicating the resource allocation types of the first UE and the UE paired therewith occupies 3 or 4 bits.

28. A user equipment (UE), comprising:
a reception module, configured to receive, from a base station, a downlink control indicator (DCI) message for the UE that satisfies a multi-user superposition transmission (MUST) mode, the DCI message comprising information indicating a resource overlapping region of the UE and a UE paired therewith; and
a processing unit, configured to determine the resource overlapping region of the UE and the UE paired therewith according to the DCI message.

29. The UE according to claim 28, wherein
the DCI message further comprises information indicating resource allocation types of the UE and the UE paired therewith.

30. The UE according to claim 28, wherein
the information indicating the resource overlapping region of the UE and the UE paired therewith comprises a bitmap having a length of N, where N is the total number of available resource positions in a system or the number of resource positions allocated to the UE; and
each bit in the bitmap corresponds to one resource position.

31. (canceled)

32. The UE according to claim 28, wherein
the resource allocation types of the UE and the UE paired therewith are the same;
the resource overlapping region is continuous; and
the information indicating the resource overlapping region of the UE and the UE paired therewith comprises the information indicating the start position of the resource overlapping region and information indicating the length of the resource overlapping region.

33. (canceled)

34. (canceled)

35. (canceled)

36. The UE according to claim 29, wherein
the resource allocation types comprise a resource allocation type 0, a resource allocation type 1 and the resource allocation type 2; and
the information indicating the resource allocation types of the UE and the UE paired therewith occupies 3 or 4 bits.
